(19) United States
(12) Patent Application Publication
(10) Pub. No.: US 2010/0188355 A1
(43) Pub. Date: Jul. 29, 2010

(54) APPARATUS AND METHOD FOR DETECTING AN OBJECT POINTED BY A USER

(75) Inventors: Kaoru SUGITA, Saitama-ken (JP); Miwako Doi, Kanagawa-ken (JP); Yasunobu Yamauchi, Kanagawa-ken (JP); Sumihiko Yamamoto, Tokyo (JP); Hideki Hayashi, Kanagawa-ken (JP); Satoshi Komatsu, Tokyo (JP); Hisashi Tsuji, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/695,380

(22) Filed: Jan. 28, 2010

(30) Foreign Application Priority Data
Jan. 28, 2009 (JP) 2009-017037

(51) Int. Cl. G06F 3/041

(52) U.S. Cl. 345/173

(57) ABSTRACT

An object is separately located from a touch panel in a touch panel coordinate system, and visible by a user via the touch panel. A touch position detector detects the user's touch position on the touch panel. The user's touch position is converted to a touch position in a world coordinate system using a position information of the touch position detector in the world coordinate system. A half-line connecting the touch position and a view position of the user is generated in the world coordinate system. It is decided whether the half-line crosses the object using a position information of the object in the world coordinate system.

### CROSS-REFERENCE TO RELATED APPLICATIONS

This application is based upon and claims the benefit of priority from Japanese Patent Application No. 2009-17037, filed on Jan. 28, 2009; the entire contents of which are incorporated herein by reference.

### FIELD OF THE INVENTION

The present invention relates to an apparatus and a method for detecting an object pointed by a user's touch operation on a touch panel.

### BACKGROUND OF THE INVENTION

Recently, a touch panel on which a user performs a pointing operation is widely used. For example, the user points an object on a display screen using his/her finger or a stylus. In order to decide that the user puts his/her finger on a surface of a touch panel and detect the finger position, various methods are developed.

For example, a light source to emit a light and an optical sensor to detect the light (as a pair) are located on both sides of an outer frame of the touch panel. When the user puts his/her finger on a surface of the touch panel, the light emitted from the light source of one side is sheltered by the finger on the surface until the light reaches the optical sensor of the other side. By using the shelter timing, the fingers position along horizontal and vertical directions on the surface can be detected. This technique is disclosed in JP-A 2006-11568 (Kokai).

In this kind of touch panel, a special material is not necessary to use on the surface of the touch panel. For example, by using a transparent acryl plate as the surface, the user can watch the opposite side through the touch panel. Accordingly, by equipping the touch panel with an existing liquid crystal display, above-mentioned function of the touch panel can be assigned.

However, the touch panel having a transparent panel surface is separately located from a display unit which displays an object to be pointed by the touch operation. Under this situation, when the user's facial position (view position) is moving, a motion parallax occurs. In this case, a position of the user's finger on the panel surface is shifted from a pointing position on the display unit. As a result, the user cannot easily point a display object on the display unit.

### SUMMARY OF THE INVENTION

The present invention is directed to an apparatus and a method for accurately deciding a display object pointed by the user's touch operation on the touch panel, even if the motion parallax occurs by moving the user's view position.

According to an aspect of the present invention, there is provided an apparatus for detecting an object pointed by a user, comprising: a first storage unit configured to store a position information of a touch position detector in a world coordinate system, the touch position detector detecting a user's touch position on a touch panel in a touch panel coordinate system; a first conversion unit configured to convert the user's touch position to a touch position in the world coordinate system using the position information; a half-line generation unit configured to generate a half-line connecting the touch position and a view position of the user in the world coordinate system; a second storage unit configured to store a position information of an object in the world coordinate system, the object being separately located from the touch panel and visible by the user via the touch panel; and a decision unit configured to decide whether the half-line crosses the object using the position information of the object.

### BRIEF DESCRIPTION OF THE DRAWINGS

FIG. 1 is a block diagram of an information processing apparatus according to a first embodiment.

FIG. 2 is another block diagram of the information processing apparatus according to the first embodiment.

FIG. 3 is a schematic diagram showing a positional relationship between a user and the information processing apparatus according to the first embodiment.

FIG. 4 is a schematic diagram showing a spatial relationship between the user and the information processing apparatus according to the first embodiment.

FIG. 5 is a schematic diagram of a coordinate system of a touch position detector according to the first embodiment.

FIG. 6 is a schematic diagram of a facial image taken by a camera unit according to the first embodiment.

FIG. 7 is a schematic diagram of an internal component of a second information storage unit according to the first embodiment.

FIG. 8 is a flow chart of processing of a first decision unit according to the first embodiment.

FIG. 9 is a schematic diagram showing decision of a cross point between a half-line and a second display unit according to the first embodiment.

FIG. 10 is a schematic diagram showing a coordinate system of the second display unit.

FIG. 11 is a schematic diagram of an internal component of a third information storage unit according to the first embodiment.

FIG. 12 is a flow chart of processing of a second decision unit according to the first embodiment.

FIG. 13 is a flow chart of processing of information processing method according to the first embodiment.

FIG. 14 is a block diagram of the information processing apparatus according to a first modification of the first embodiment.

FIG. 15 is a schematic diagram showing an example of a drag operation between two displays according to a second modification of the first embodiment.

FIG. 16 is a flow chart of processing during the drag operation according to the second modification.

FIG. 17 is a flow chart of processing at completion of the drag operation according to the second modification.

FIG. 18 is a schematic diagram showing a positional relationship between the user and the information processing apparatus according to a second embodiment.

FIG. 19 is a block diagram of the information processing apparatus according to the second embodiment.

FIG. 20 is a schematic diagram of internal component of a real object position storage unit according to the second embodiment.

FIG. 21 is a schematic diagram of a convex approximating a real object according to the second embodiment.

FIG. 22 is a flow chart of processing of a third decision unit according to the second embodiment.

FIG. 23 is a schematic diagram showing decision of a cross point between a half-line and the convex approximating the real object according to the second embodiment.

FIG. 24 is a block diagram of another example of the information processing apparatus according to the second embodiment.

FIG. 25 is a schematic diagram showing an example of a drag operation from the display to the real object according to the second embodiment.

FIG. 26 is a schematic diagram showing an example of a drag operation from the real object to the display according to the second embodiment.

FIG. 27 is a schematic diagram showing a positional relationship between the user and the information processing apparatus according to the other embodiment.

### DETAILED DESCRIPTION OF THE EMBODIMENTS

Hereinafter, embodiments of the present invention will be explained by referring to the drawings. The present invention is not limited to the following embodiments.

### The First Embodiment

In the first embodiment, by using a touch panel, the information processing apparatus to decide the user's pointed object on a display unit separately located from the touch panel.

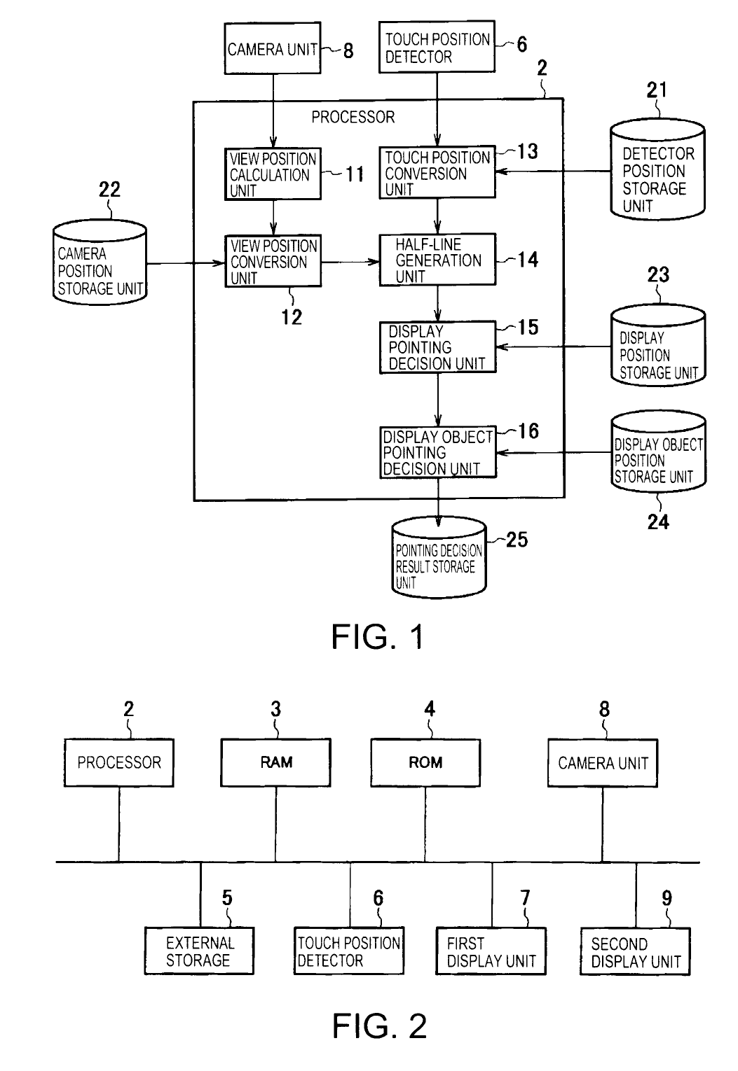

FIG. 1 is a block diagram of the information processing apparatus of the first embodiment. As shown in FIG. 1, the information processing apparatus includes a view position calculation unit 11, a fourth information storage unit (camera position storage unit) 22, a second conversion unit (view position conversion unit) 12, a first information storage unit (detector position storage unit) 21, a first conversion unit (touch position conversion unit) 13, a half-line generation unit 14, a second information storage unit (display position storage unit) 23, a first decision unit (display pointing decision unit) 15, a third information storage unit (display object position storage unit) 24, and a second decision unit (display object pointing decision unit) 16.

The view position calculation unit 11 calculates a user's view position from the user's facial image taken from a camera unit 8. The fourth information storage unit 22 stores a position information of the camera unit 8 in a world coordinate system (space defined by world coordinates). The second conversion unit 12 calculates a view position in the world coordinate system, using the position information of the camera unit 8. The first information storage unit 21 stores a position information of a touch panel detector (touch panel) 6 in the world coordinate system. The first conversion unit 13 calculates a touch position in the world coordinate system from a touch position detected by the touch panel detector 6, using the position information of the touch panel.

The half-line generation unit 14 generates information of a half-line connecting the view position and the touch position in the world coordinate system. The second information storage unit 23 stores a position information of a display unit (displaying an object visible by the user via the touch panel) in the world coordinate space. The first decision unit 15 decides whether the half-line crosses the display unit, using the position information of the display unit. The third information storage unit 24 stores a position information of a display object in a screen coordinate system of the display unit. The second decision unit 16 decides whether the half-line crosses the display object on the display unit decided to cross the half-line, using the position information of the display object.

The information processing apparatus of the first embodiment is packaged as shown in FIG. 2. The information processing apparatus equips a processor 2, a main storage (RAM) 3, a read-only storage (ROM) 4, an external storage 5, a touch position detector 6, a first display unit 7, a camera unit 8, and a second display unit 9. As shown in FIG. 1, the processor 2 logically equips the view position calculation unit 11, the second conversion unit 12, the first conversion unit 13, the half-line generation unit 14, the first decision unit 15 and the second decision unit 16, as a module (logical circuit) of hardware resource. For example, the main storage 3 equips the first information storage unit 21, the fourth information storage unit 22, the second information storage unit 23, the third information storage unit 24, and the fifth information storage unit 25.

A program, which is executed by the information processing apparatus of the first embodiment, is read from the external storage 5 to the main storage 3 or recorded into the read-only storage 4, and executed by the processor 2. The main storage 3 stores a parameter and a calculation result of a program executed.

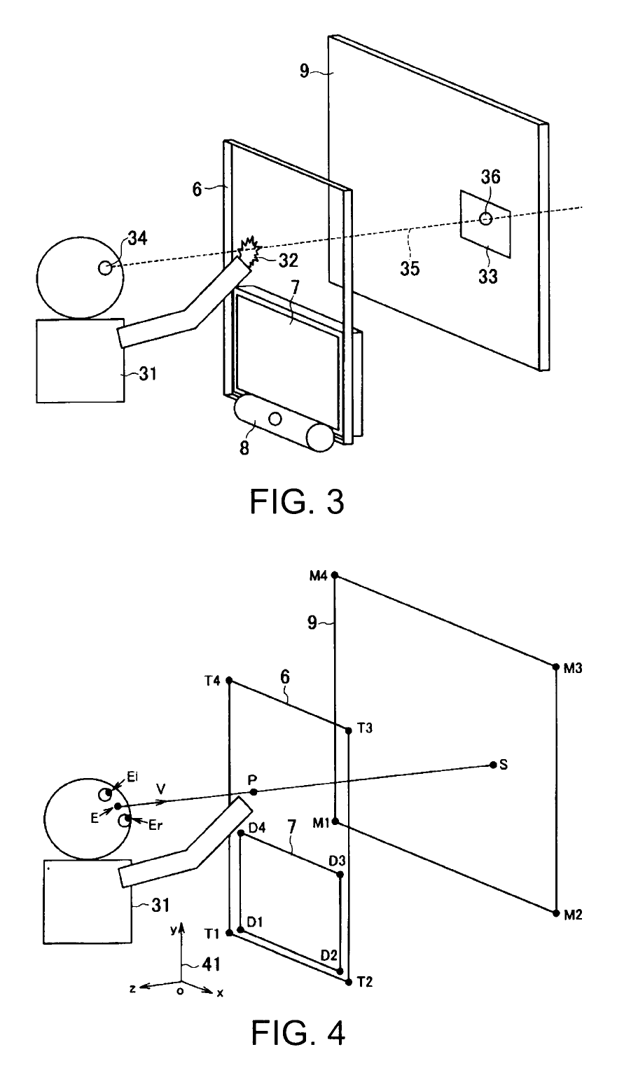

FIG. 3 shows a special relationship among each apparatus. The touch position detector 6 is located in front of a user (operator) 31. The touch position detector 6 is a touch panel to detect and output the user's touch position, when the user touches a surface of the panel with his/her finger or a stylus. In the first embodiment, as the touch position detector 6, an optical touch panel “XYFer (registered trademark)” having 24 inches manufactured by EIT Co., Ltd is used. The touch position detector 6 is rotated clockwise as 90 degrees to have vertically a longer length, i.e., located to vertically stand. A surface of this panel is a transparent acryl plate. Accordingly, the user can easily observe an object existing at the other side of the touch position detector 6.

A first display unit 7 is located at a lower half region of the touch position detector 6 to make contact with the touch position detector 6. A second display unit 9 is located separately (the other side) from the touch position detector 6. The first display unit 7 and the second display unit 9 respectively have a display to output a video and a graphics processor to generate the video. As the first display unit 7, for example, a liquid crystal monitor having 19 inches is used. As the second display unit 9, for example, a large-sized display such as a projection screen having 100 inches is used.

The camera unit 8 is located at a lower part of the touch position detector 6. The camera unit 8 equips a video camera to take a facial image of the user 31 at real time, and a video input processor to input the facial image taken. As the camera unit 8, for example, a Web camera connectable to a USB is used. In the first embodiment, an image having a resolution VGA ((640 pixels)×(480 pixels)) is taken at 30 times every second.

In the positional relationship of FIG. 3, when the user 31 touches on a panel of the touch position detector 6 with his/her finger, a touch position (pointing position) 32 on the panel is detected, and a view position 34 of the user 31 is detected from the facial image (taken by the camera unit 8). Then, a half-line 35 connecting the touch position 32 and the view position 34 is generated, and a cross position 36 between the half-line 35 and the second display unit 9 is calculated. Accordingly, it is decided whether the user 31 points a display object 33 on the second display unit 9, based on positional relationship between the cross position 36 and the display object 33. In the same way, it is decided whether the user 34 points a display object on the first display unit 7.

In order to represent a coordinate of each apparatus in the positional relationship of FIG. 3, a world coordinate system 41 is defined as shown in FIG. 4. In this case, a right-hand coordinate system is used. Briefly, from a view position of the user 31, a horizontal-right direction is defined as x-axis, a vertical upper direction is defined as y-axis, and this side direction is defined as z-axis.

A rectangle on a surface of the touch position detector 6 is defined as points T1, T2, T3 and T4. A rectangle on a surface of the first display unit 7 is defined as points D1, D2, D3 and D4. A rectangle on a surface of the second display unit 9 is defined as points M1, M2, M3 and M4. A position of a right eye of the user 31 is defined as a point Er, a position of a left eye of the user 31 is defined as a point El, a view position of the user 31 is defined as a point E, a touch position of the user 31 on the touch position detector 6 is defined as a point P, and a touch position of the user 31 on the second display unit 9 is defined as a point S. All T1-T4, D1-D4, M1-M4, Er, El, E, P and S are points in a three-dimensional space.

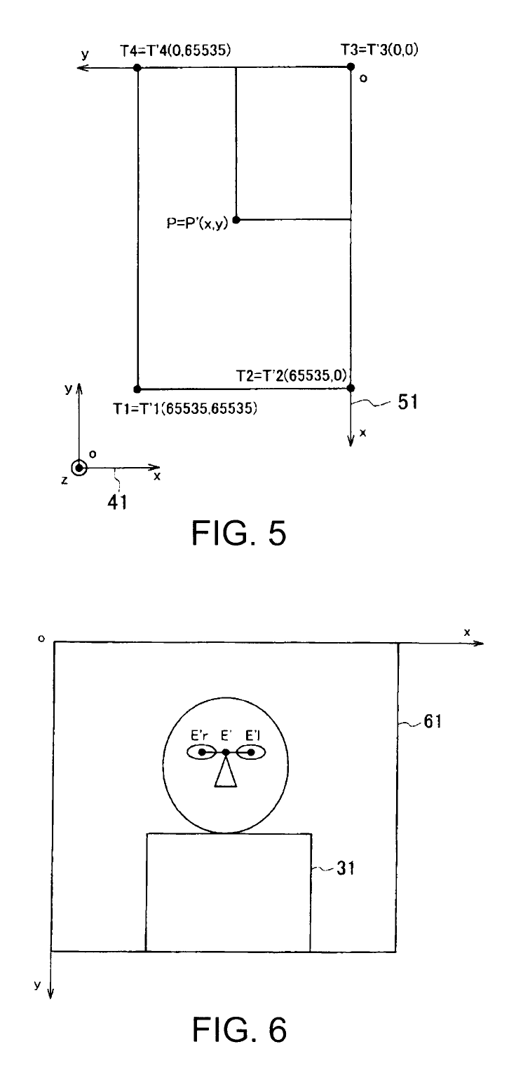

As shown in FIG. 5, a coordinate system on a panel surface of the touch position detector 6 is defined as a touch panel coordinate system 51. In correspondence with points T1, T2, T3 and T4 in a world coordinate system 41, points T′1, T′2, T′3 and T′4 are defined in the touch panel coordinate system 51. When the user 31 touches a point P (touch point), the touch position detector 6 detects a point P′ (x,y) as touch position information.

As the touch position detector 6 in the first embodiment, “XYFer (registered trademark)” is located by rotating clockwise as 90 degrees. Assume that calibration of the touch position detector 6 is accurately performed. In this case, As an output value of a detection position from the touch position detector 6 along a horizontal direction, an integral number which values “0˜65535” are interiorly divided by a distance from both side of the panel surface to the detection position is output. Briefly, “(x,y)=(0,0)” is output at a point T′3, “(x,y)=(0,65535)” is output at a point T′4, and “(x,y)=(0,32768)” is output at a mid point between points T′3 and T′4. As to a vertical direction, the same processing is executed.

The touch position detector 6 outputs a coordinate P(t)(x, y, z, 1) of a touch position P (in three-dimensional space) on the touch panel coordinate system 51. In this coordinate, P(t) is a homogenious coordinate.

As to “XYFer (registered trademark)” as the touch position detector 6, the panel surface is a rectangular flat shape. Accordingly, two sides of the touch panel along horizontal and vertical directions are defined as x-axis and y-axis, and z-coordinate is defined as “0”. However, if the panel surface of the touch position detector 6 is curved, z-coordinate is defined based on a depth of the touch position.

Furthermore, when the user 31 touches the panel surface with both hands, the touch position detector can detect a plurality of touch positions. In case of using information of a plurality of touch positions on the panel surface, the touch position detector 6 outputs a plurality of coordinates P(t)(x, y, z, 1) in three-dimensional space, as the number of detection positions.

By using information of the touch position detector 6 read from the first information storage unit 21, the first conversion unit 13 calculates a touch position in the world coordinate system from the touch position detected by the touch position detector 6. The information of the touch position detector 6 represents a positional relationship between the touch panel coordinate system 51 and the world coordinate system 41. A coordinate conversion from the touch panel coordinate system to the world coordinate system is represented as a homogenious transformation matrix M(t) having “(4 rows) X (4 columns)”. This matrix M(t) may be determined by previously measuring a position of the touch position detector 6. Alternatively, by equipping a position sensor (for positioning) with the touch position detector 6, the matrix M(t) may be determined by acquiring the position of the touch position detector 6 from the position sensor. As to the processing to calculate the matrix M(t) from the position/posture of the touch position detector 6, a well-known method in the computer-vision field or the spatial positioning field can be used.

By using the matrix M(t), the first conversion unit 13 converts a coordinate P(t) of the touch position in the touch panel coordinate system 51 to a coordinate P(w) of the touch position in the world coordinate system. This conversion processing is represented as following equation (1).

P(w)=M(t) P(t) (1)

In the equation (1), P(w) is a homogenious coordinate. The first conversion unit 13 outputs P(w).

Furthermore, if the user can carry the touch position detector 6 and change a position/direction thereof, a position sensor for positioning with a magnetism or a supersonic wave is equipped with the touch position detector 6, and a position/posture of the touch position detector 6 in the world coordinate system is acquired.

From the facial image of the user 31 (taken by the camera unit 8), the view position calculation unit 11 calculates a view position of the user 31 in a camera coordinate system of an image taken by the camera unit 8. As to the facial image, correction of a lens distortion, and correction of a center position on a CCD surface, are arbitrarily executed. In order to calculate the view position, a well-known method for estimating the view position using facial feature in the image processing field is used.

As shown in FIG. 6, assume that a position of right eye is E′r(c) and a position of left eye is E′l(c). A view position E′ (c) is, for example, an interior division point to equally divide a distance between E′r(c) and E′l(c). Furthermore, if the eye more dominant than the other is previously decided for the user 31, which is the right eye, E′r(c) may be substituted for the view position E′ (c). Conversely, if the eye more dominant than the other is the left eye, E′l(c) may be substituted for the view position E′ (c).

Furthermore, except for usage of facial feature on the image, a color-marker is painted between both eyes of the user's face. By extracting a color of the marker and detecting a position of the color, the view position of the user may be output.

On the assumption that a view point of the user 31 exists at a predetermined depth from the camera unit 8, the view position calculation unit 11 outputs E(c) (x, y, z, 1) as view position information in the camera coordinate system. In order to estimate the depth z where the view point exists, size information of the face in the image is used. In the view position information, E(c) is a homogenious coordinate.

By using position information of the camera unit 8 (read from the fourth information storage unit 22), the second conversion unit 12 calculates a view position of the user 31 in the world coordinate system 41 from the view position E(c) of the user 31 in the camera coordinate system (calculated by the view position calculation unit 11).

The position information of the camera unit 8 represents a coordinate conversion from the camera coordinate system to the world coordinate system 41. This conversion is represented as a homogenious transformation matrix M(c) having “(4 rows)×(4 columns)”. This matrix M(c) may be determined by previously measuring a position of the camera unit 8. Alternatively, by equipping a position sensor (for positioning) with the camera unit 8, the matrix M(c) may be determined by acquiring the position of the camera unit 8 from the position sensor. As to the processing to calculate the matrix M(c) from the position/posture of the camera unit 8, a well-known method in the computer-vision field or the spatial positioning field can be used.

By using the matrix M(c), the second conversion unit 12 converts the view position E(c) in the camera coordinate system to a view position E(w) in the world coordinate system 41. This conversion processing is represented as following equation (2).

E(w)=M(c) E(c) (2)

In the equation (2), E(w) is a homogenious coordinate. The second conversion unit 12 outputs E(w).

In the first embodiment, in order to acquire the view position of the user 31, a single camera unit 8 is used. However, the depth may be acquired by a stereo imaging, i.e., two cameras may be used. Furthermore, the position sensor can be used.

The view position E(w) of the user 31 in the world coordinate system 41 (converted by the second conversion unit 12) is set as a start point. The half-line generation unit 14 generates a half-line from the start point to the touch position P(w) in the world coordinate system 41 (converted by the first conversion unit 13). Concretely, the start point E (w) of the half-line, and a unit vector of a direction vector P(w)−E(w), are generated.

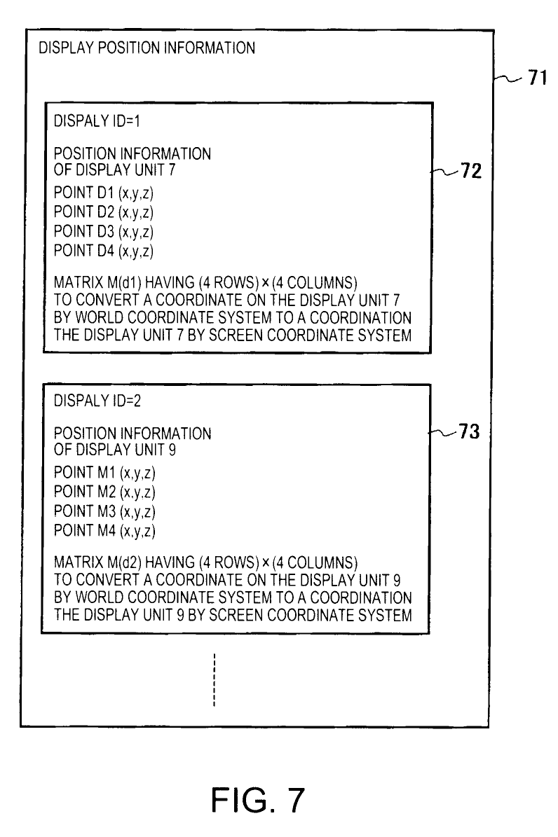

As shown in FIG. 7, the second information storage unit 23 stores display position information 71. The display position information 71 includes information 72 of the first display unit 7 and information 73 of the second display unit 9, i.e., information such as a position, a posture and a shape of each display unit in the world coordinate system 41. Information of each display unit includes an ID assigned to each display unit from “1” in order, position information of the display unit, and homogenious transformation matrices M(d1) and M(d2) having “(4 rows)×(4 columns)” to convert a coordinate on the display unit from the world coordinate system 41 to the screen coordinate system.

In the display position information 71, a position of a corner point of the display unit in the world coordinate system 41 is defined counterclockwise from the user side of the display unit. As the reason of counterclockwise the right-hand system is applied to the coordinate system of the first embodiment. However, clockwise-definition can be also processed by a method for packaging the program.

In case of using a rectangular display such as the first display unit 7 and the second display unit 9, the rectangular display is defined as four points in the world coordinate system 41. Furthermore, if the display has a curved surface, the curved surface is approximated as a set of planes.

In the first embodiment, the first display unit 7 and the second display unit 9 are used. In this case, four points D1, D2, D3 and D4 (in the world coordinate system 41) composing a rectangle of the first display unit 7, and four points M1, M2, M3 and M4 (in the world coordinate system 41) composing a rectangle of the second display unit 9, are stored. When a location of the display unit changes in the world coordinate system 41, the four points are updated at any time. When an ID of the display unit is indicated, information of the display unit corresponding to the ID is output from the second information storage unit 23.

The first decision unit 15 reads information of each display unit in order from the second information storage unit 23, and decides whether the half-line (generated by the half-line generation unit 14) spatially crosses the display unit. If the half-line crosses a plurality of display units, the first decision unit 15 outputs information of the display unit having a cross position nearest to the view position of the user.

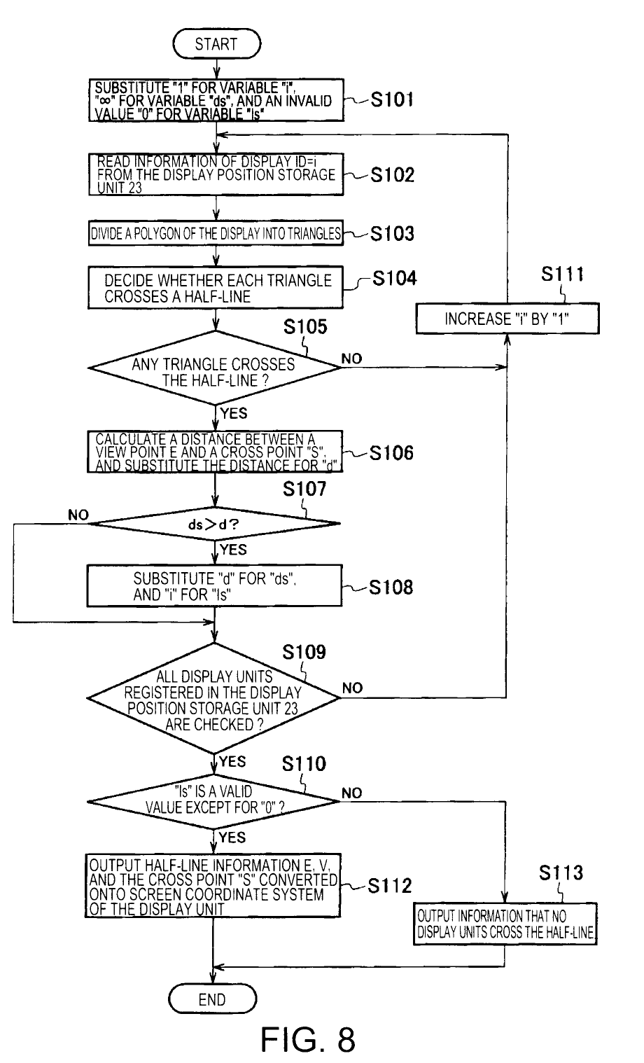

Next, processing of the first decision unit 15 is explained by referring to a flow chart of FIG. 8.

(A) At S101, as initialization processing, “1” is substituted for a variable “i” representing an ID of the display unit. An infinite value “∞” is substituted for a variable “ds” as a distance between the view position E and the cross position of the display unit (nearest to the view position). An invalid value “0” is substituted for a variable “Is” representing a display unit (crossing the half-line) nearest to the view point. At S102, information of the display unit “ID=i” is read from the second information storage unit 23.

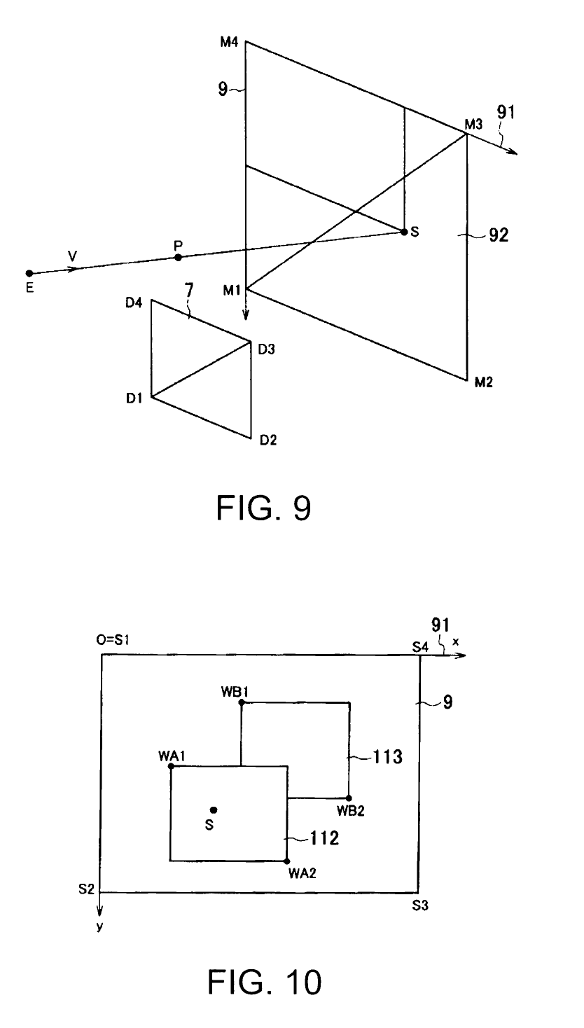

At S103, a polygon of the display unit (display screen) is divided into a set of triangles not mutually overlapped. As a method for dividing the polygon (defined by a contour line) into triangles, a well-known method in the computer graphics field is used. For example, a function “GLUTess” of a utility library “GLU” in a graphics library “OpenGL” is used. As shown in FIG. 9, a rectangle D1, D2, D3 and D4 on a surface of the first display unit 7 is divided into a triangle D1, D2 and D3, and a triangle D1, D3 and D4. A rectangle M1, M2, M3 and M4 on a surface of the second display unit 9 is divided into a triangle M1, M2 and M3, and a triangle M1, M3 and M4.

(B) At S104, as to all triangles divided from the surface, a point crossing the half-line on a plane on which the triangle exists is calculated. It is decided whether the point is included in the triangle. As processing to decide a cross point between the half-line and the triangle, a well-known method in the computer graphics field is used. If the cross point is included in any triangle divided from the surface, it is decided that the half-line crosses the surface. This processing is well known as the ray tracing in computer graphics. At S105, if the half-line crosses any triangle, processing is forwarded to S106. If the half-line does not cross any of triangles, processing is forwarded to S111.

(C) At S106, a distance between the view position E and the cross position S is calculated, and substituted for a variable d. At S107, the variable “ds” is compared to the variable “d”. If the variable “ds” is larger than the variable “d”, processing is forwarded to S108. If the variable “ds” is not larger than the variable “d”, processing is forwarded to S109. At S108, the variable “d” is substituted for the variable “ds”, and “i” is substituted for the variable “Is”.

(D) At S109, it is decided whether all display units registered in the second information storage unit 23 is checked. If all display units registered in the second information storage unit 23 is already checked, processing is forwarded to S110. If at least one display unit is not checked, processing is forwarded to S111. At S111, the variable “i” is increased by “1”, and processing is forwarded to S102.

(E) At S110, it is decided whether the variable “Is” is a valid value except for “0”. If the variable “Is” is a valid value except for “0”, processing is forwarded to S112. If the variable “Is” is “0”, processing is forwarded to S113.

(F) At S112, information E and V of the half-line, and a converted value of the cross position S onto the screen coordinate system 91, are output. For example, as shown in FIG. 9, when the half-line crosses at a point S on the second display unit 9, a coordinate of the point S is converted onto the screen coordinate system 91 of the second display unit 9, and output. “Conversion onto the screen coordinate system 91” represents conversion to a coordinate on two-dimensional plane defined by resolution of the second display unit 9. For example, in case of a display having 1920 pixels along a horizontal axis and 1080 pixels along a vertical axis, as shown in FIG. 10, “S1=(0,0), S2=(0,1079), S3=(1919,1079), S4=(1919,0)” are output, and processing is completed. In this case, conversion from a cross position S (w) in the world coordinate system to a coordinate S (s) in the screen coordinate system 91 of the display unit 9 is represented as following equation (3). In the equation (3), M(d2) is stored as information 73 of the second display unit 9, which is a homogenious coordinate matrix having “(4 rows) X (4 columns)” to convert a coordinate on the display unit 9 from the world coordinate system to the screen coordinate system.

S(s)=M(d2)S(w) (3)

S(s) is a homogenious coordinate. On the other hand, at S113, information that no display units cross the half-line is output, and processing is completed.

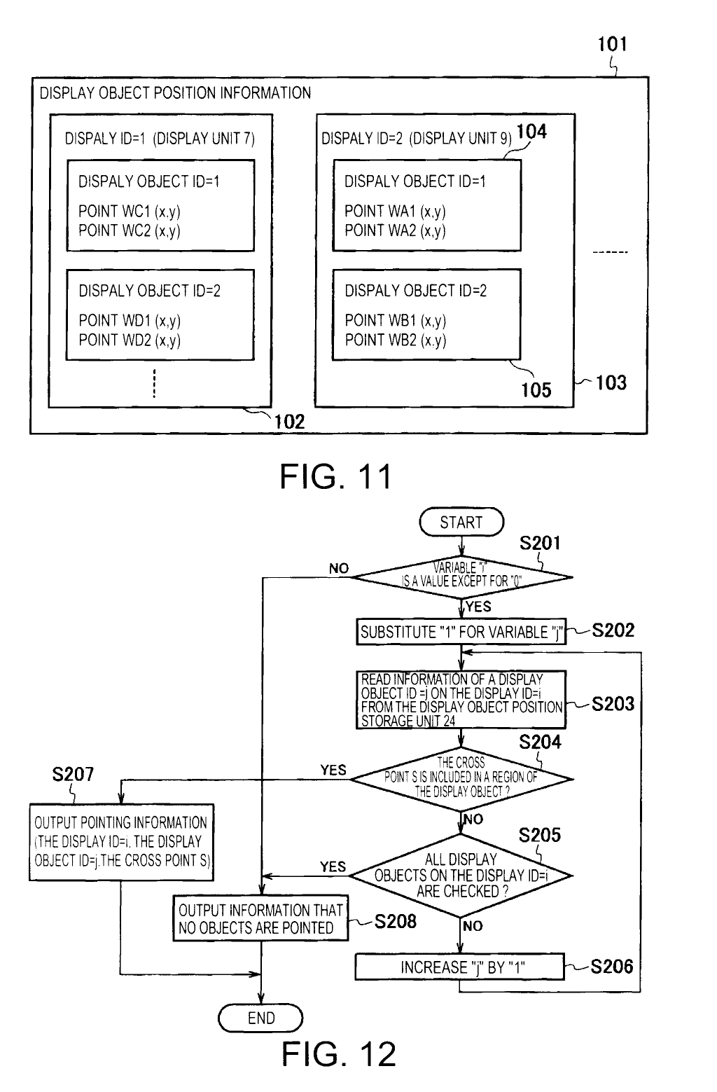

As shown in FIG. 11, the third information storage unit 24 stores display object position information 101. The display object position information 101 includes position information of a plurality of display objects such as information 102 of the first display unit 7 and information 103 of the second display unit 9.

For example, as shown in FIG. 10, the second display unit 9 is a display of window system, and two rectangular windows 112 and 113 are displayed with overlapping. In this case, in information 103 of the second display unit 9, information 104 of the window 112 and information 105 of the window 113 are stored. The information 104 of the window 112 includes an ID of a display object, a point WA1 (minimum x-coordinate, minimum y-coordinate) and a point WA2 (maximum x-coordinate, maximum y-coordinate) of a rectangle of the window 112. The ID of display object is assigned in order from a window positioned nearer to the view point of the user. Briefly, the window 112 is positioned nearer to the view point than the window 113. Accordingly, an ID in the information 104 of the window 112 is smaller than an ID in the information 105 of the window 113. Information of the third information storage unit 24 is updated by moving of a position of a display object, and generation/deletion of the display object. When an ID of the display unit and an ID of the display object are indicated, information of the display object corresponding to the IDs is output.

The second decision unit 16 reads the display object position information from the third information storage unit 24 in order, and decides whether a cross position S is included in a region of the display object on the display unit (output from the first decision unit 15) crossing the half-line. Processing of the second decision unit 16 is explained by referring to FIG. 12.

(A) At S201, it is decided whether the variable “i” of the display unit crossing the half-line is a value except for “0”. If the variable “i” is the value except for “0”, processing is forwarded to S202. If the variable “i” is “0”, processing is forwarded to S208.

(B) At S202, as initialization processing, “1” is substituted for a variable “j” representing a display object. At S203, information of the display object “ID=j” on the display unit “ID=i” is read from the third information storage unit 24. At S204, it is decided whether the cross position S is included in a region of the display object “ID=j”. If the cross position s is included, processing is forwarded to S207. If the cross position s is not included, processing is forwarded to S205. For example, it is decided that the cross position S is included in the window 112 defined by diagonal points WA1 and WA2.

(C) At S205, it is decided whether all display objects registered in the third information storage unit 24 is checked. If all display objects is already checked, processing is forwarded to S208. If at least one display object is not checked, processing is forwarded to S206. At S206, a value of the variable “j” is increased by “1”, and processing is forwarded to S203.

(D) At S207, a value of the variable “i” (ID of the display unit), a value of the variable “j” (ID of the display object), and a coordinate of the cross position S, are output as a pointing decision result (information of the user's pointed object), and processing is completed. On the other hand, at S208, information that no objects are pointed is output as the pointing decision result, and processing is completed.

By above processing, as to a plurality of display units 7 and 9 separately located from the touch position detector 6, it is decided that the user 31 points a display object on these displays by a touch operation. Then, a series of processing to output information of the display object is completed.

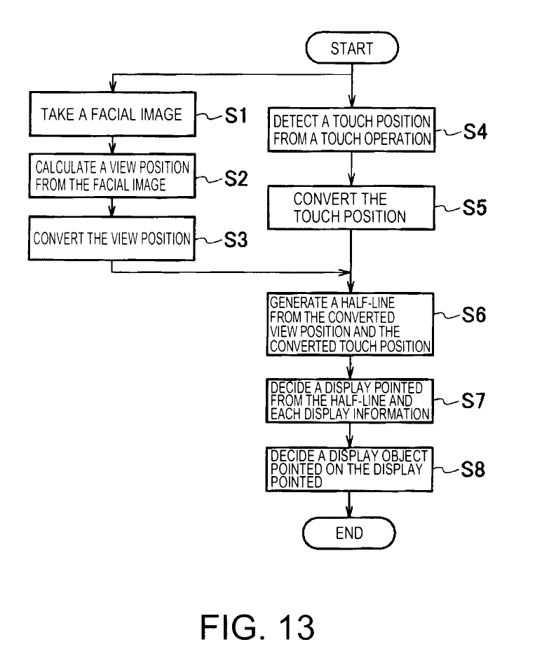

Next, in the information processing apparatus of the first embodiment, one example of an information processing method is explained by referring to a flow chart of FIG. 13.

(A) At S1, the first display unit 7 and the second display unit 9 respectively output a display object visible for a user 31 via the touch position detector 6. The camera unit 8 takes a facial image of the user 31. At S2, the view position calculation unit 11 calculates a view position of the user 31 from the facial image of the user 31 (taken by the camera unit 8). At S3, the second conversion unit 12 calculates a view position in the world coordinate system from the view position of the user 31 (calculated by the view position calculation unit 11) and a position of the camera unit 8 in the world coordinate system.

(B) At S4, the touch position detector 6 detects a touch position of the user 31. At S5, the first conversion unit 13 calculates a touch position in the world coordinate system from the touch position detected by the touch position detector 6.

(C) At S6, the half-line generation unit 14 generates a half-line connecting the view position of the user 31 and the touch position in the world coordinate system.

(D) At S7, the first decision unit 17 reads position information of the first display unit 7 and the second display unit 9 from the second information storage unit 23. Then, the first decision unit 15 decides whether the half-line (generated by the half-line generation unit 14) crosses the first display unit 7 and the second display unit 9 respectively.

(E) At S8, the second decision unit 16 reads information of a display object on the display unit which is decided to cross the half-line, from the third information storage unit 24. Then, the second decision unit 16 decides whether the half-line crosses the display object. If it is decided that the half-line crosses the display object, information of the display object is stored in the fifth information storage unit 25.

As mentioned-above, in the first embodiment, even if a motion parallax occurs when the user 31 moves his/her view position, the motion parallax is corrected. In other words, it is decided that the user 31 points the display object on the second display unit 9 (separately located from the touch position detector 6) by a touch operation. Briefly, by operating the touch position detector 6, the user 31 can accurately point the display object on the second display unit 9.

In the first embodiment, the first display unit 7 and the second display unit 9 are prepared. However, the number of display units and a location position of display units are not limited. Furthermore, in the first embodiment, the first display unit 7 is located to make contact with the touch position detector, and the second display unit 9 is separately located from the touch position detector. However, a plurality of display units may be separately located from the touch position detector.

(The First Modification)

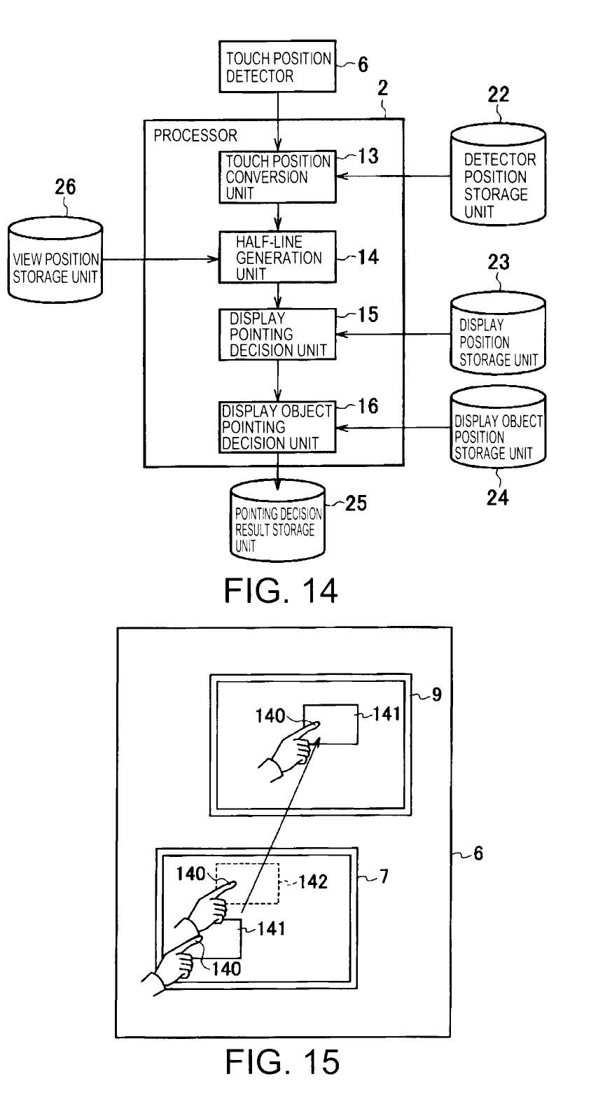

In the first embodiment, a view position of the user is acquired using the view position calculation unit 11 and the second conversion unit 12. However, the case that the view position is assumed to be fixed is explained. As shown in FIG. 14, the information processing apparatus of the first modification further includes a view position storage unit 26 to previously store information of the view position of the user. The information of the view position is directly input to the half-line generation unit 14. In this case, the view position calculation unit 11 and the second conversion unit 12 in FIG. 1 are omitted.

(The Second Modification)

In the first embodiment, when the user performs a touch operation, a decision result as the pointed object is acquired. In the second modification, after the decision result is acquired, when the user performs a drag operation, processing to move a display position of the display object is explained.

After the user touches the touch position detector (touch panel) 6, the user moves a touch position of his/her finger without detaching the finger from the touch panel. After moving his/her finger on the touch panel, the user detaches the finger from the touch panel. This operation is called “drag operation”. Furthermore, when the user moves a position of his/her face while fixing a touch position of his/her finger on the touch panel, the user's pointing position on the display unit relatively moves. In this case, the same processing of the second modification is also used.

An example of the drag operation is explained by referring to FIG. 15. The user touches a display object 141 on the first display unit 7 with his/her finger 140. The display object 141 pointed by the user for drag operation is called “moving display object”. After that, when the user moves the finger 140, a display object for dragging 142 (different from the moving display object 141) is displayed based on moving of the finger 140. The display object for dragging 142 represents the user's dragging operation. In this case, the display object for dragging 142 may have the same shape of the moving display object 141. Alternatively, in order not to conceal a background region on the display, the display object for dragging 142 may be displayed transparently or displayed as a contour shape of line drawing. After that, when the user detaches the finger 140 from the second display unit 9, the display object for dragging 142 is not displayed, and a position of the moving display object 141 moves to the detach position on the second display unit 9. Furthermore, without the display object for dragging 142, the display object 141 may be directly moved on the first display unit 7 and the second display unit 9, based on the drag operation.

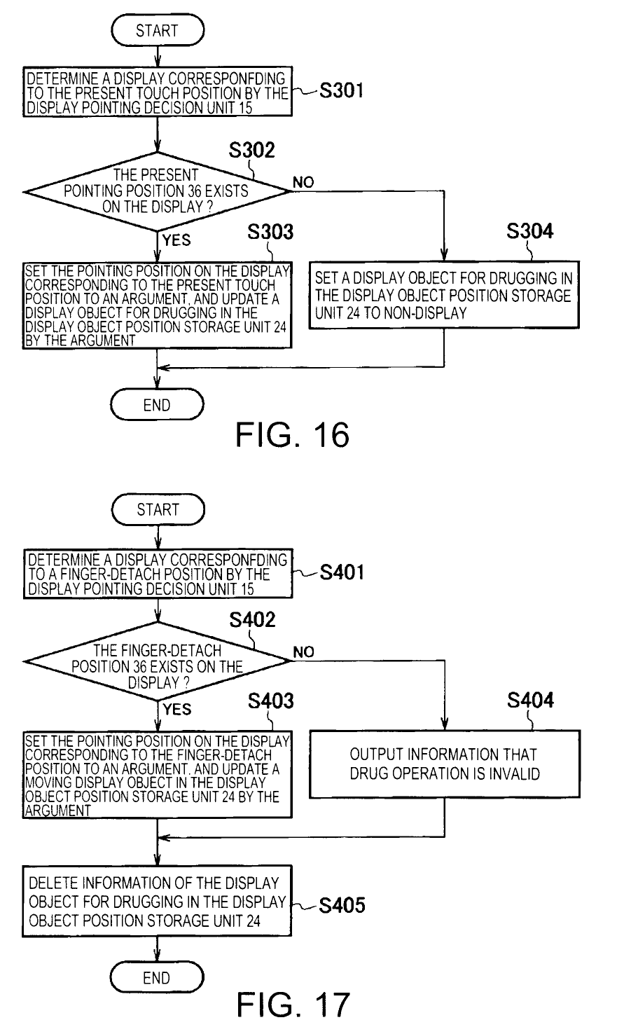

Next, as to the drag operation, in case that the user moves a touch position of his/her finger without detaching the finger from the touch panel, processing of the second modification is explained by referring to FIG. 16.

(A) Before S301, when the user performs touch operation, the pointing decision result (the pointed display object) is output in the information processing apparatus of FIG. 1. Then, information of the moving display object 141 (pointed by the user) is copied and registered in the third information storage unit 24, as information of the display object for dragging 142. At S301, by using processing of the first decision unit 15 in FIG. 8, a display unit corresponding to the present touch position is determined.

(B) At S302, the second decision unit 16 decides whether the present touch position is included in any display unit. If the present touch position is included, processing is forwarded to S303. If the present touch position is not included in any of display units, i.e., if the user points an object except for the display unit, processing is forwarded to S304.

(C) At S303, a touch position (corresponding to the present touch position) on the display unit is set to an argument, and a position of the display object for dragging in the third information storage unit 24 is updated using the argument. Briefly, the position of the display object for dragging is updated to the present touch position. After that, processing is completed.

(D) At S304, the display unit to output the display object does not exist. Accordingly, the second decision unit 16 sets information of the display object for dragging in the third information storage unit 24 to non-display. After that, processing is completed.

Next, in case that the user completes the drag operation by detaching his/her finger from the touch panel, processing of the second modification is explained by referring to FIG. 17.

(A) At S401, by using processing of the first decision unit 15 in FIG. 8, a display unit corresponding to a detach position of the finger (a touch position where the user touches immediately before) is determined.

(B) At S402, the second decision unit 16 decides whether the detach position is included in any display unit. If the detach position is included in any display unit, processing is forwarded to S403. If the detach position is not included in any of display units (the user detaches the finger after pointing an object except for the display unit), processing is forwarded to S404.

(C) At S403, a touch position (corresponding to the detach position) on the display unit is set to an argument, and a position of the moving display object in the third information storage unit 24 is updated using the argument. Briefly, the position of the moving display object is updated to the detach position. After that, processing is forwarded to S405.

(D) At S404, the display unit to output the display object does not exist. Accordingly, the second decision unit 16 outputs information that the drag operation is invalid. After that, processing is forwarded to S405.

(E) At S405, information of the display object for dragging is deleted from the third information storage unit 24, and processing is completed.

In the second modification, an example that the display object is moved by the drag operation is explained. Whether the display object is moved by the drag operation, or the display object is copied (by the drag operation) and displayed at a moving destination position while the display object is continually displayed at a moving source position, can be arbitrarily defined based on the operation. For example, when the user drags on the first display unit 7, the display object is moved on the first display unit 7. When the user drags from the first display unit 7 to the second display unit 9 (i.e., onto a different display unit), the display object is copied and displayed on the second display unit 9.

### The Second Embodiment

In the second embodiment, in addition to the first embodiment, by using position information of a real object except for the display unit, it is decided whether the user points the real object via a touch panel.

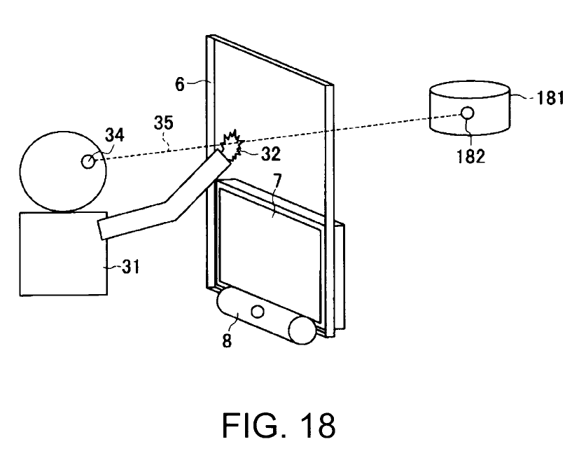

In the second embodiment, as shown in FIG. 18, a real object 181 exists instead of the second display unit 9, which is different from component and positional relationship of FIG. 3. Other units have the same component and positional relationship as FIG. 3. Accordingly, the overlapped explanation is omitted.

In positional relationship of FIG. 18, when the user 31 touches on a panel of the touch position detector 6 with his/her finger, a half-line 35 connecting a touch position 32 of the finger and a view position 34 of the user 31 (detected from a facial image taken by the camera unit 8) is generated. Then, a cross position 182 of the half-line 35 on the real object 181 is calculated. Accordingly, whether the user 31 points the real object 181 is decided by positional relationship between the cross position 182 and the real object 181.

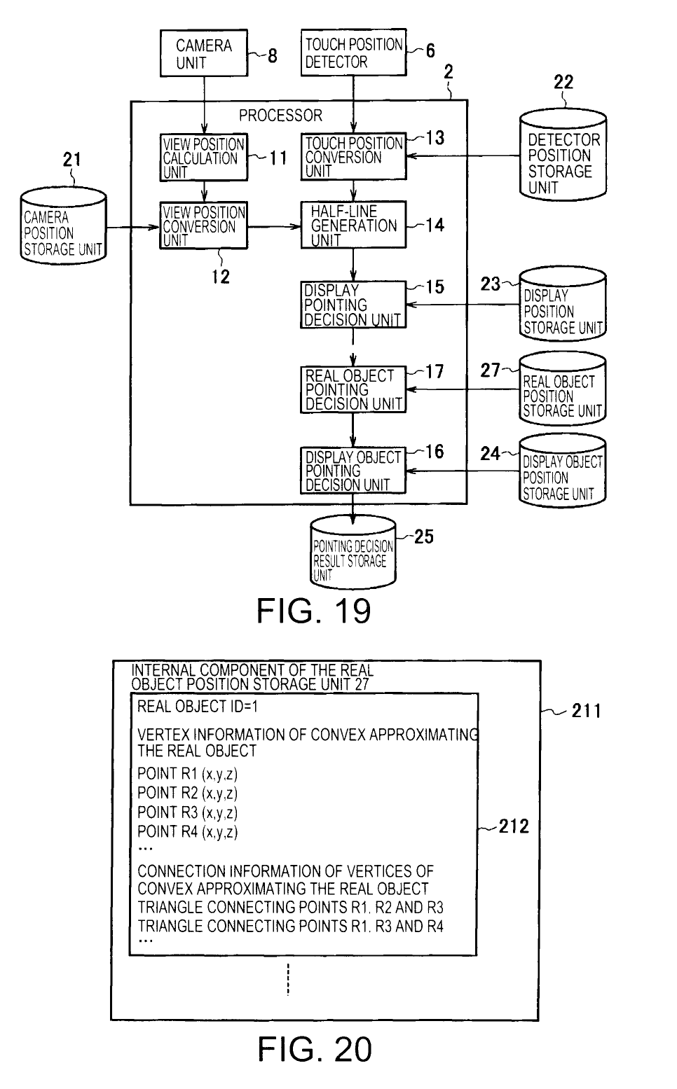

As shown in FIG. 19, an information processing apparatus of the second embodiment further includes a real object position storage unit 27 and a third decision unit (real object pointing decision unit) 17, which are different from the information processing apparatus of FIG. 1. The real object position storage unit 27 stores an information of a real object (visible for a user via the touch position detector 6) in the world coordinate system. The third decision unit 17 decides whether the half-line crosses the real object.

As shown in FIG. 20, the real object position storage unit 27 stores a position, a posture and a shape of a plurality of real objects in the world coordinate system, as a real object position information 211. The real object position information 211 includes information 212 of the real object 181.

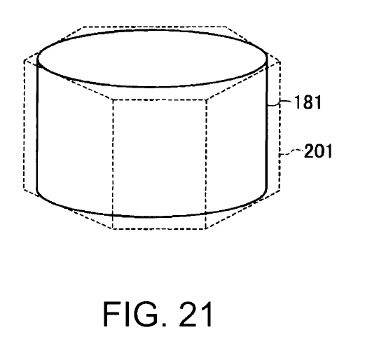

As shown in FIG. 21, shape information of the real object is represented as a set 201 of a polygon, which is a convex approximating an outward form of the real object 181. Information 212 of the real object 181 includes coordinates of vertices composing the set 201 of a polygon, and connection information of the vertices. When a position/shape of the real object 181 is changed in the world coordinate system, the information 212 is updated. When an ID of the real object is indicated, information of the real object corresponding to the ID is output from the real object position storage unit 27.

The third decision unit 17 reads information of each real object in order from the real object position storage unit 27, and decides whether the half-line (generated from the half-line generation unit 14) spatially crosses the real object. If the half-line crosses a plurality of real objects, the third decision unit 17 selects one real object having a cross position nearest to a view position of the user, from the plurality of real objects.

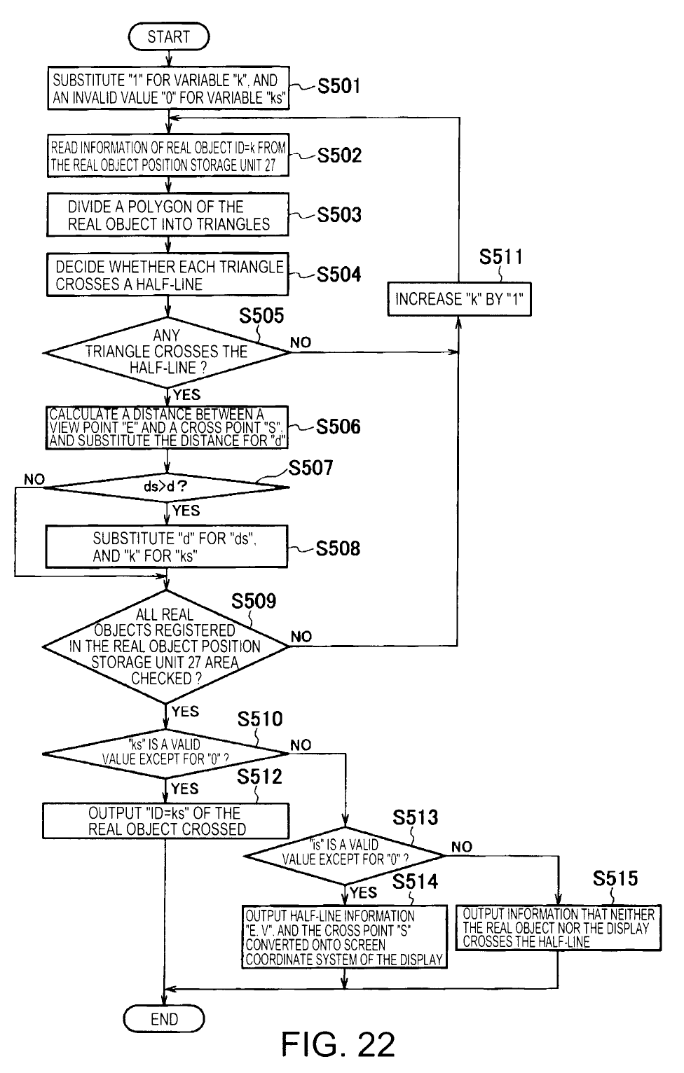

Next, processing of the third decision unit 17 is explained by referring to a flow chart of FIG. 22.

(A) At S501, as initialization processing, “1” is substituted for a variable “k” representing an ID of the real object. An invalid value “0” is substituted for a variable “ks” representing a real object (crossing the half-line) nearest to the view position. As to a variable “ds” representing a distance between the view position E and a cross position of the display unit (nearest to the view position), an output value from the first decision unit 15 is used.

(B) At S502, information of the real object “ID=k” is read from the real object position storage unit 27. At S503, a polygon of the real object is divided into a set of triangles not mutually overlapped. This processing is same as S103.

Next, at S504, as to all triangles, a point crossing the half-line on a plane on which the triangle exists is calculated. It is decided whether the point is included in the triangle. This processing is same as S104.

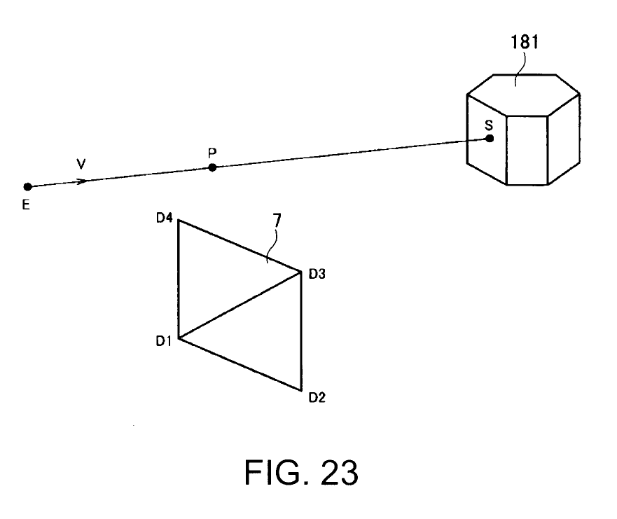

(C) At S505, if the half-line crosses any triangle, processing is forwarded to S506. If the half-line does not cross any of triangles, processing is forwarded to S511. At S506, as shown in FIG. 23, a distance between the view position E and the cross position S is calculated, and substituted for a variable d. At S507, the variable “ds” is compared to the variable “d”. If the variable “ds” is larger than the variable “d”, processing is forwarded to S508. If the variable “ds” is not larger than the variable “d”, processing is forwarded to S509.

(D) At S508, the variable “d” is substituted for the variable “ds”, and “k” is substituted for the variable “ks”. At S509, it is decided whether all real objects registered in the real object position storage unit 27 is checked. If all real objects registered in the real object position storage unit 27 is already checked, processing is forwarded to S510. If at least one real object is not checked, processing is forwarded to S511. At S511, the variable “k” is increased by “1”.

(E) At S510, it is decided whether the variable “ks” is a valid value except for “0”. If the variable “ks” is a valid value except for “0”, processing is forwarded to S512. If the variable “ks” is “0”, processing is forwarded to S513.

(F) At S512, information of the real object “ID=ks” crossing the half line is output, and processing is completed.

(G) At S513, it is decided whether the variable “is” is a valid value except for “0”. If the variable “is” is a valid value except for “0”, processing is forwarded to S514. If the variable “is” is “0”, processing is forwarded to S515. At S514, information E and V of the half-line, and a converted value of the cross position S onto the screen coordinate system, are output, and processing is completed. This processing is same as S112. At S515, information that neither the real object nor the display unit crosses the half-line is output, and processing is completed.

If the third decision unit 17 decides that the half-line crosses a real object and the first decision unit 15 decides that the half-line crosses a display unit, the third decision unit 17 decides whether a cross position of the display unit is nearer to a view position (in the world coordinate system) than a cross position of the real object. If the cross position of the display unit is farer from the view position than the cross position of the real object, information of the real object “ID=ks” is output. On the other hand, if the cross position of the display unit is nearer to the view position than the cross position of the real object, the second decision unit 16 decides whether the half-line crosses a display object on the display unit.

As mentioned-above, in the second embodiment, even if a motion parallax occurs by moving a view point of the user 31, the motion parallax is corrected. Briefly, it is decided that the user 31 points an object displayed on the first display unit 7 (separately located from the touch position detector 6) or a real object 181 by a touch operation via a touch panel. Accordingly, by operating the touch position detector 6, the user can accurately point the object displayed on the display unit or the real object (remotely located from the user).

In the second embodiment, a location position of the real object (and the display unit), and the number of the real objects (and the display units), are not limited. Furthermore, in the second embodiment, the first display unit 7 is located to make contact with the touch position detector 6, and the real object 181 is located far from a view point of the user. However, a plurality of display units and the real object may be located far from the view point of the user.

(The First Modification)

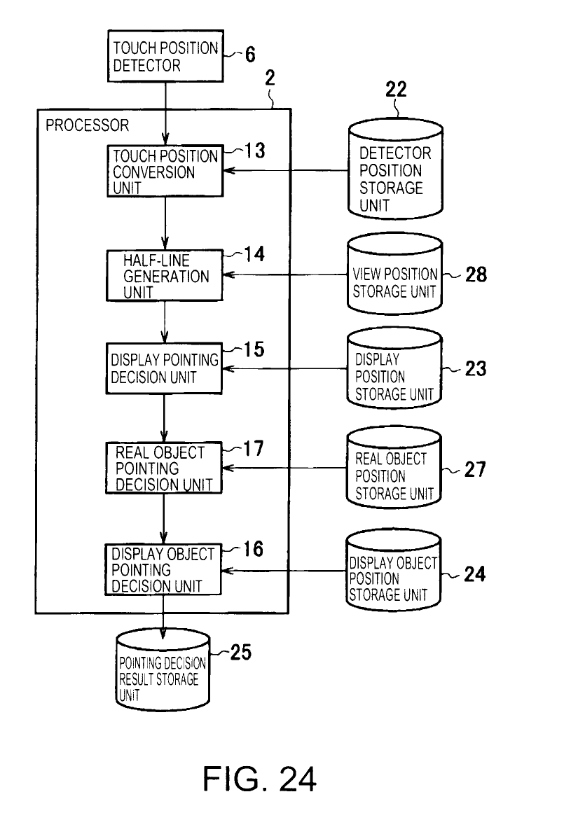

In the second embodiment, a view position of the user is acquired using the view position calculation unit 11 and the second conversion unit 12. However, the case that the view position is assumed to be fixed is explained. As shown in FIG. 24, the information processing apparatus of the first modification further includes a view position storage unit 28 to previously store information of the view position of the user. The information of the view position is directly input to the half-line generation unit 14. In this case, the view position calculation unit 11 and the second conversion unit 12 in FIG. 1 are omitted.

(The Second Modification)

In the information processing apparatus of FIG. 19, when the user performs a touch operation, a pointing decision result (the display object or the real object) is acquired. In the second modification, after the pointing decision result is acquired, processing at the case that the user performs a drag operation is explained. The case that the user drags between two display units can be realized by processing of the first embodiment. Accordingly, the case that the user drags from the display unit to the real object, or from the real object to the display unit, is explained.

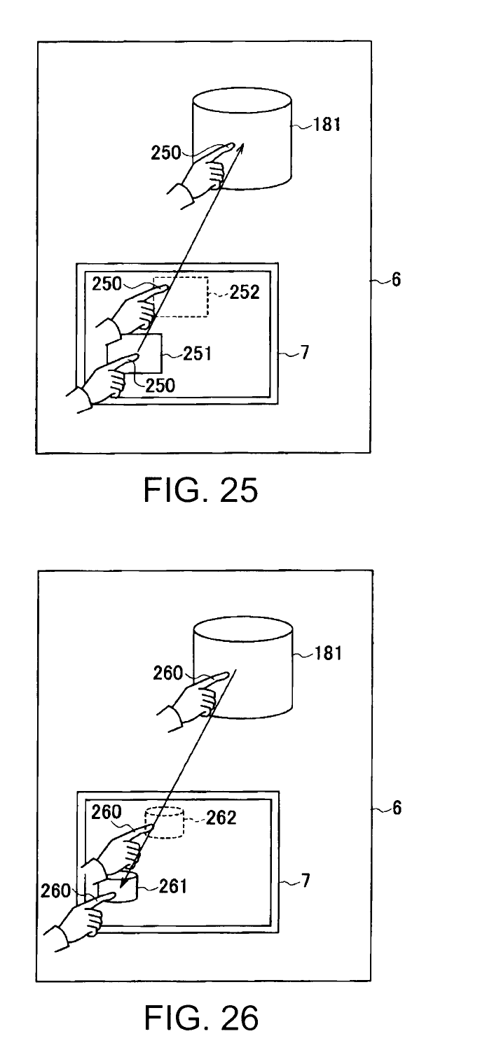

First, by referring to FIG. 25, the case that the user drags from the first display unit 7 to the real object 181 is explained. The user touches a display object 251 on the first display unit 7 with his/her finger 250. In this case, the display object 251 pointed by the user (to move by drag operation) is called “moving display object”. After that, when the user moves the finger 250, a display object for dragging 252 (different from the display object 251) representing the user's drag operation is displayed, based on moving of the finger 250.

After that, when the user detaches his/her finger 250 from the real object 181, processing corresponding to the moving display object 251 and the real object 181 is respectively executed. This processing can be defined based on characteristic of the real object 181. For example, if the real object 181 is a printer, information of the display object 251 is printed as a predetermined format. Furthermore, without the display object for dragging 252, the display object 251 may be directly moved on the first display unit 7, based on the drag operation.

Furthermore, processing of the drag operation from the display unit to the real object in FIG. 25 can be executed using processing in the second modification of the first embodiment. Briefly, a touch position where the user detaches the finger from the touch panel is decided using not only information of the display unit but also information of the real object position storage unit 27 in FIG. 20. In this case, when the user drags the display object onto the real object via the touch panel, whether the display object is deleted or continually displayed at a moving source position can be voluntarily defined based on the operation contents.

Next, by referring to FIG. 26, the case that the user drags from the real object 181 to the first display unit 7 is explained. The user touches the real object 181 with his/her finger 260. After that, the user moves a touch position of the finger 260 from the real object 181. When the touch position is moved into the first display unit 7 first, a display object for dragging 262 (an image of the real object 181) is displayed on the first display unit 7. The display object for dragging 262 represents the real object 181 dragged by the user.

After that, when the user detaches the finger 260 from the first display unit 7, information of the real object 181 is displayed as a display object 261. This information can be defined based on characteristic of the real object 181. For example, if the real object 181 is some monitoring camera, the display object 261 may be a video taken by the monitoring camera. If the real object 181 is some building viewable from the user, the display object 261 may be information related to the building.

Without the display object for dragging 262, the display object 261 may be directly moved on the first display unit 7, based on the drag operation.

Furthermore, processing of the drag operation from the real object to the display unit in FIG. 26 can be executed using processing of the drag operation in the first embodiment. Briefly, when the user performs drags operation, the user's touch position on the touch panel is decided using not only information of the display unit but also information of the real object position storage unit 27 in FIG. 20. In addition to this, an image of the real object (moving display object) is registered to the third information storage unit 24.

Furthermore, in the second modification, processing corresponding to the drag operation between the display unit and the real object is explained. However, even if the user points a first real object and drags the first real object into a second real object, this processing can be realized in the same way.

### Another Embodiment

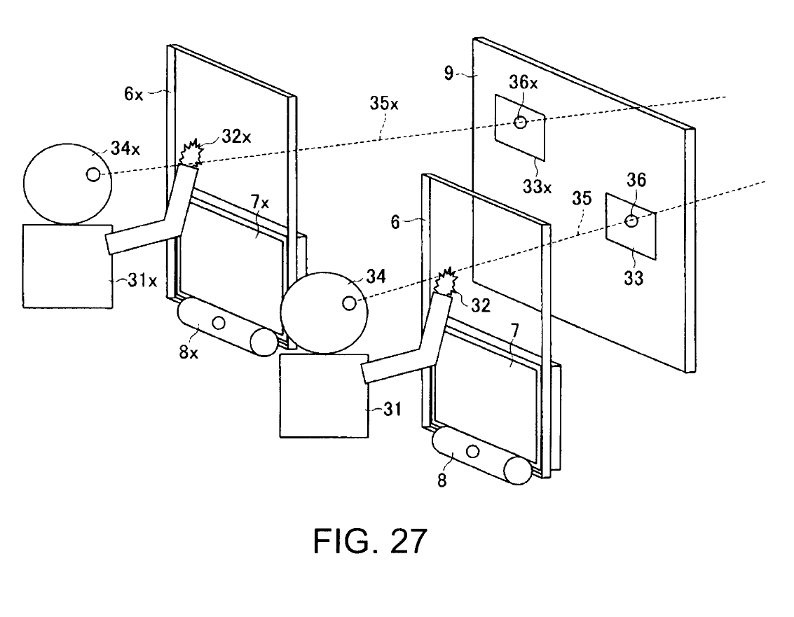

For example, as shown in FIG. 27, a touch position detector 6x, a first display unit 7x and a camera unit 8x may be located adjacent to the touch position detector 6, the first display unit 7 and the camera unit 8, respectively. In a positional relationship of FIG. 27, two users 31 and 31x touch a panel of the touch position detectors 6 and 6x respectively. In this case, by using a common world coordinate system, a touch position (pointed position by the finger) 32 and 32x, a view position 34 and 34x of the users 31 and 31x (detected from facial images from camera units 8 and 8x), are detected respectively. Then, a half-line 35 connecting the touch position 32 and the view position 34, and a half-line 35x connecting the touch position 32x and the view position 34x, are generated respectively. Last, a cross position 36 of the half-line 35 on the second display unit 9, and a cross position 36x of the half-line 35x on the second display unit 9, are calculated respectively. Accordingly, it is decided that two users 31 and 31x respectively point two display objects 33 and 33x on the second display unit 9, based on a positional relationship between the cross position 36 and the display objects 33, and a positional relationship between the cross position 36x and the display objects 33x.

The information processing apparatus of above-mentioned embodiments can be utilized by installing onto a personal computer and a cellular-terminal of next generation, a monitoring system and a control system.

Other embodiments of the invention will be apparent to those skilled in the art from consideration of the specification and embodiments of the invention disclosed herein. It is intended that the specification and embodiments be considered as exemplary only, with the scope and spirit of the invention being indicated by the claims.

What is claimed is:

1. An apparatus for detecting an object pointed by a user, comprising:
a first storage unit configured to store a position information of a touch position detector in a world coordinate system, the touch position detector detecting a user's touch position on a touch panel in a touch panel coordinate system;
a first conversion unit configured to convert the user's touch position to a touch position in the world coordinate system using the position information;
a half-line generation unit configured to generate a half-line connecting the touch position and a view position of the user in the world coordinate system;
a second storage unit configured to store a position information of an object in the world coordinate system, the object being separately located from the touch panel and visible by the user via the touch panel; and
a decision unit configured to decide whether the half-line crosses the object using the position information of the object.

2. An apparatus for detecting an object pointed by a user, comprising:
a first storage unit configured to store a position information of a touch position detector in a world coordinate system, the touch position detector detecting a user's touch position on a touch panel;
a first conversion unit configured to convert the user's touch position to a touch position in the world coordinate system using the position information;
a half-line generation unit configured to generate a half-line connecting the touch position and a view position of the user in the world coordinate system;
a second storage unit configured to store a position information of a display unit in the world coordinate system, the display unit being separately located from the touch panel and displaying an object visible by the user via the touch panel;
a first decision unit configured to decide whether the half-line crosses the display unit using the position information of the display unit;
a third storage unit configured to store a position information of the object in a screen coordinate system of the display unit; and
a second decision unit configured to decide whether the half-line crosses the object on the display unit using the position information of the object, when the first decision unit decides that the half-line crosses the display unit.

3. The apparatus according to claim 2, further comprising:
a camera unit configured to take a facial image of the user;
a view position calculation unit configured to calculate the user's view position in a camera coordinate system of the camera unit from the facial image;
a fourth storage unit configured to store a position information of the camera unit in the world coordinate system; and
a second conversion unit configured to convert the user's view position to the view position in the world coordinate system, using the position information of the camera unit.

4. The apparatus according to claim 2, wherein
the view position in the world coordinate system is previously fixed.

5. The apparatus according to claim 2, wherein,
if a plurality of display units exists in the world coordinate system,
the first decision unit decides whether the half-line crosses each of the plurality of display units.

6. The apparatus according to claim 5, wherein,
if the first decision unit decides that the half-line crosses at least two display units,
the first decision unit selects one display unit having a cross position nearest to the view position in the world coordinate system, from the at least two display units, and
the second decision unit decides whether the half-line crosses the object displayed on the selected display unit.

7. The apparatus according to claim 2, wherein,
if a plurality of objects is displayed on the display unit,
the second decision unit decides whether the half-line crosses each of the plurality of objects.

8. The apparatus according to claim 2 further comprising:
a real object position storage unit configured to store a position information of a real object in the world coordinate system, the real object being visible by the user via the touch panel; and
a third decision unit configured to decide whether the half-line crosses the real object using the position information of the real object.

9. The apparatus according to claim 8, wherein,
if a plurality of real objects exists in the world coordinate system,
the third decision unit decides whether the half-line crosses each of the plurality of real objects.

10. The apparatus according to claim 9, wherein,
if the third decision unit decides that the half-line crosses at least two real objects,
the third decision unit selects one real object having a cross position nearest to the view position in the world coordinate system, from the at least two real objects.

11. The apparatus according to claim 8, wherein,
if it is decided that the half-line crosses the display unit and the real object,
the third decision unit decides whether a cross position of the display unit is nearer to the view position than a cross position of the real object in the world coordinate system, and
if the third decision unit decides that the cross position of the display unit is nearer to the view position,
the second decision unit decides whether the half-line crosses the object displayed on the display unit.

12. A method for detecting an object pointed by a user, comprising:
detecting a user's touch position on a touch panel by a touch position detector;
converting the user's touch position to a touch position in a world coordinate system, using a position information of the touch position detector in the world coordinate system;
generating a half-line connecting the touch position and a view position of the user in the world coordinate system;
deciding whether the half-line crosses a display unit using a position information of the display unit in the world coordinate system, the display unit being separately located from the touch panel and displaying an object visible by the user via the touch panel; and
deciding whether the half-line crosses the object on the display unit using a position information of the object in a screen coordinate system of the display unit, when it is decided that the half-line crosses the display unit.
